(19) United States
(12) Patent Application Publication
(10) Pub. No.: US 2016/0103290 A1
(43) Pub. Date: Apr. 14, 2016

(54) DISTRIBUTION CABLE WITH BIDIRECTIONAL BREAKOUT LOCATIONS

(71) Applicant: ADC Telecommunications, Inc., Berwyn, PA (US)

(72) Inventors: Todd Loeffelholz, Minnetonka, MN (US); Erik J. Gronvall, Bloomington, MN (US)

(21) Appl. No.: 14/870,290

(22) Filed: Sep. 30, 2015

Related U.S. Application Data
(60) Provisional application No. 62/057,786, filed on Sep. 30, 2014.

(51) Int. Cl. G02B 6/44; G02B 6/255; G02B 6/25; G02B 6/38

(52) U.S. Cl. CPC G02B 6/4475; G02B 6/4495; G02B 6/3885; G02B 6/4476; G02B 6/255; G02B 6/25

(57) ABSTRACT

A distribution cable arrangement includes optical fibers extending along a length; a jacket defining one or more access regions along the length to provide access to the optical fibers; and a closure disposed around each of the access regions. One or more fibers are each cut at each access region to provide first and second cut ends. Both cut ends are routed out of the jacket and terminated by optical connectors. The first and second optical connectors are positioned relative to the closure to be mateable to optical cables that are external of the closure.

### CROSS REFERENCE TO RELATED APPLICATION

This application claims the benefit of U.S. Provisional Application No. 62/057,786, filed Sep. 30, 2014, and titled “Distribution Cable with Bidirectional Breakout Locations,” the disclosure of which is hereby incorporated herein by reference.

### BACKGROUND

Optical networks are becoming prevalent in part because service providers want to deliver high bandwidth communication capabilities to customers. An example network may include one or more central offices that connects a number of end subscribers (also called end users) in a network. The central offices may additionally connect to a larger network such as the Internet and/or to a public switched telephone network (PSTN). The network may also include fiber distribution hubs (FDHs) having one or more optical splitters that generate a number of individual fibers that may lead to the premises of an end user.

Improvements are desired.

### SUMMARY

The present disclosure relates generally to a distribution cable defining one or more intermediate break-out locations at which various optical fibers of the distribution cable can be accessed.

In accordance with some aspects of the disclosure, a distribution cable arrangement includes optical fibers extending along a length; a jacket defining an access region to provide access to at least one of the optical fibers; and a closure disposed around the jacket to cover the access region. At least one of the optical fibers is cut to provide a first cut end and a second cut end. Both cut ends are routed out of the jacket through the access region. The first cut end is terminated at a first optical connector and the second cut end is terminated at a second optical connector. The first and second optical connectors are positioned relative to the closure to be mateable to optical cables that are external of the closure.

In some examples, the first and second optical connectors are disposed within the closure. For example, the first and second optical connectors can be received at internal ports of ruggedized optical adapters carried by the closure. In certain implementations, the closure includes a clam-shell configuration.

In other examples, the first and second optical connectors are disposed external of the closure. For example, the first and second optical connectors can be ruggedized. In certain implementations, the closure includes a heat-recoverable closure.

In some implementations, the first and second cut ends are directly terminated by the first and second optical connectors, respectively. In other implementations, the first and second cut ends are spliced to tether cables that are directly terminated by the first and second optical connectors, respectively.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 illustrates an example optical cable defining an example break-out location at an intermediate position along a length of the cable;

FIG. 2 is a perspective view of one end of an example closure disposed at a break-out location of a cable;

FIG. 3 is a perspective view of an opposite end of the closure of FIG. 2;

FIG. 4 is an exploded view of the closure of FIG. 2;

FIG. 5 is an axial cross-sectional view of the closure and cable of FIG. 2;

FIG. 6A is a schematic diagram of the optical cable of FIG. 1 where the first cut end is directly terminated by a first optical connector and the second cut end is directly terminated by a second optical connector;

FIG. 6B is a schematic diagram of the optical cable of FIG. 1 where the first cut end is optical spliced to a first stub fiber that is directly terminated by the first optical connector and the second cut end is optical spliced to a second stub fiber that is directly terminated by the second optical connector;

FIG. 7 is a perspective view of one end of another example closure disposed at a break-out location of a cable;

FIG. 8 is a perspective view of an opposite end of the closure of FIG. 7;

FIG. 9 is an exploded view of the closure of FIG. 7;

FIG. 10 is an axial cross-sectional view of the closure and cable of FIG. 7;

FIG. 11 is a perspective view of an example cable having first and second optical connectors extending outwardly from a heat recoverable closure; and

FIG. 12 is another perspective view of the example cable of FIG. 11.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

The present disclosure relates generally to a distribution cable defining one or more intermediate break-out locations at which various optical fibers of the distribution cable can be accessed.

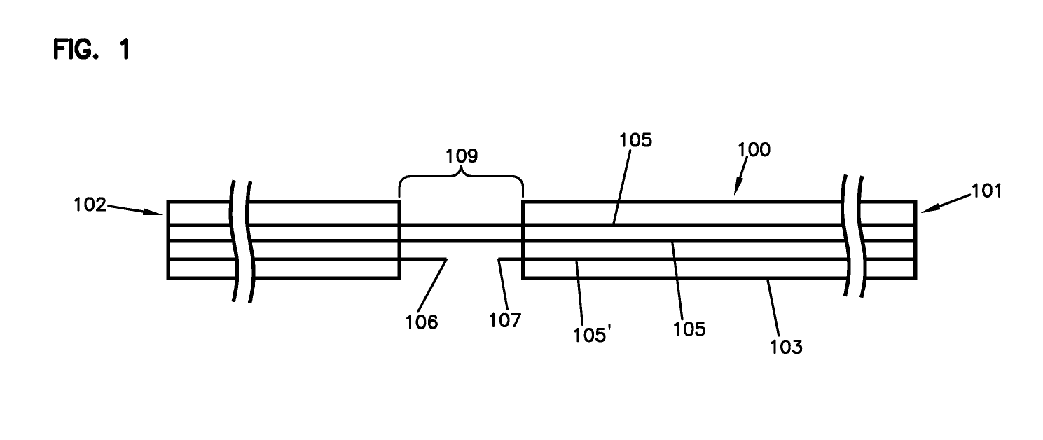

FIG. 1 illustrates an optical cable 100 extending along a length from a first end 101 to a second end 102. The optical cable 100 includes multiple optical fibers 105 surrounded by a jacket 103. In certain implementations, a strength member 108 can extend along the length of the cable 100 within the jacket 103. In certain implementations, the jacket 103 is an overjacket that surrounds multiple optical cables that each include a jacket 104 surrounding optical fibers 105. In certain examples, the strength member 108 can extend within the overjacket 103 external of the cables 104. In other examples, other types of optical fiber cables are suitable.

The jacket (i.e., overjacket) 103 of the cable 100 defines one or more access regions 109 located at various intermediate positions along the length of the cable 100. A portion of the jacket 103 is removed at each access region 109 to provide access to the optical fibers 105 or cables 104. In some examples, a window can be cut through the circumferential wall of the jacket 103 to provide access to the optical fibers 105 or cables 104 within the jacket 103. In other examples, the jacket 103 can be partially or fully removed from an axial segment of the cable 100. In certain examples, a portion of a buffer tube 104 also is removed at the access region 109 to provide access to the optical fibers 105 or cables 104 within the buffer tube 104.

At least one optical fiber 105′ of the optical fibers 105 is cut at or near the access region 109 to form a first cut end 106 and a second cut end 107. In certain examples, at least a first optical cable 104′ of the optical cables 104 is cut to form the first cut end 106 and the second cut end 107. At least the first cut end 106 is routed out of the jacket 103 at the access region 109. The first cut end 106 is terminated by a first optical connector 110. In an example, a single-fiber connector 110 (e.g., an LC connector, an SC connector, a DLX connector, and LX.5 connector, etc.) is terminated to the first cut end 106 of the optical fiber 105′. In another example, a multi-fiber connector 110 (e.g., an MPO connector, and HMFOC connector, etc.) is terminated to the first cut end 106 of the optical cable 104′. For ease of description, the remainder of this disclosure will refer to cutting an optical cable 104′ to produce the first and second cut ends 106, 107. It will be understood, however, that one or more optical fibers 105 can be utilized in place of the cables 104.

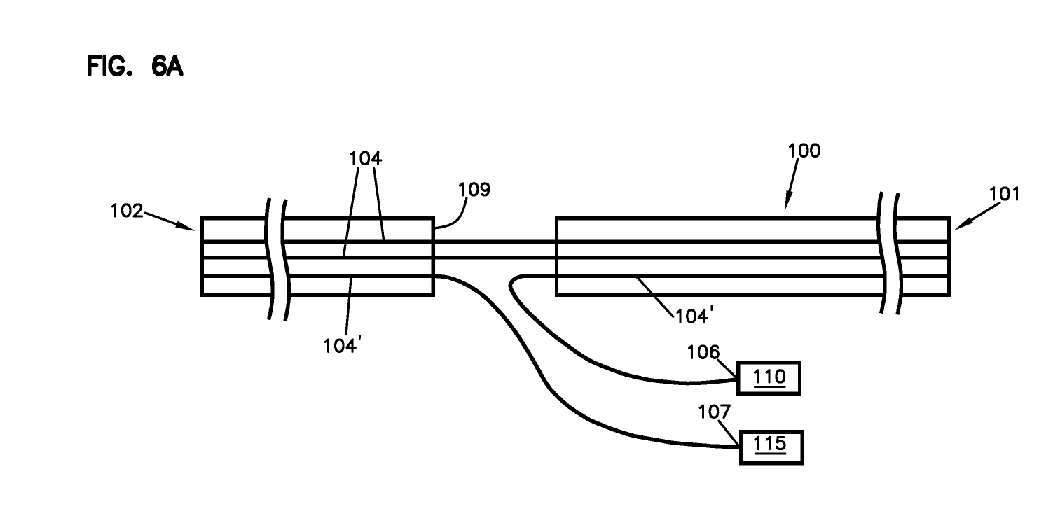

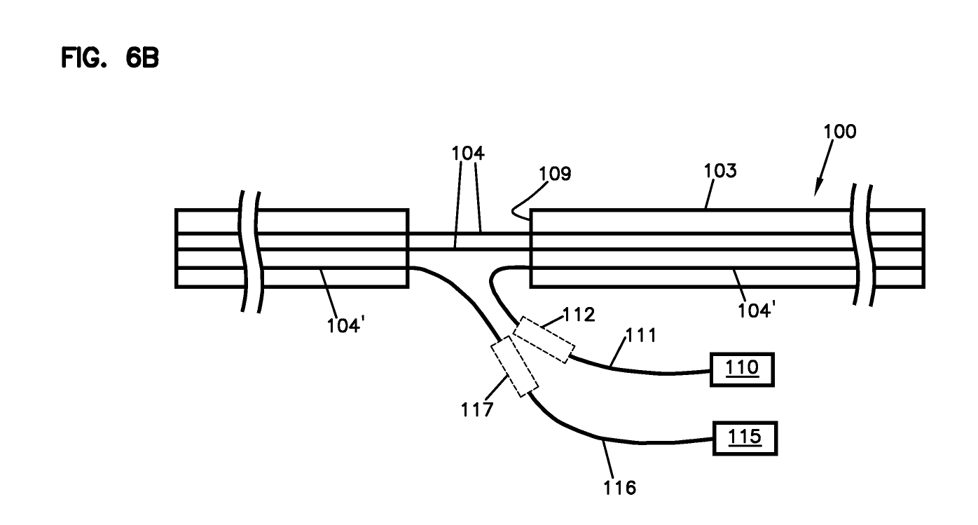

As the term is used herein, “terminated” refers to optically coupling the first cut end 106 to an optical connector 110 either directly or indirectly. In some examples, the first cut end 106 can be directly terminated to the optical connector 110. In such examples, the optical connector 110 is mounted directly to the first cut end 106 (e.g., see FIG. 6A). In other examples, the first cut end 106 can be spliced at a splice location 112 to an optical stub fiber 111 that is directly terminated by the optical connector 110 (e.g., see FIG. 6B).

In certain implementations, a plurality of the separate cables 104 can be cut at the access region 109. In such implementations, the cut ends of the optical cables 104 are routed out of the jacket 103. In some implementations, each cut end can be terminated by a separate optical connector 110. In other implementations, one or more of the cut ends can be left unterminated.

A closure mounts over the cable 100 at the access region 109. The closure is configured to cover the access region 109 of the cable 100. The first optical connector 110 is positioned relative to the closure to be mateable to an optical cable that is external of the closure. In an example, the first optical connector 110 is plugged into an internal port of an optical adapter carried by the closure. In another example, the first optical connector 110 is disposed external of the closure. In examples, unterminated cut ends can be disposed within the closure.

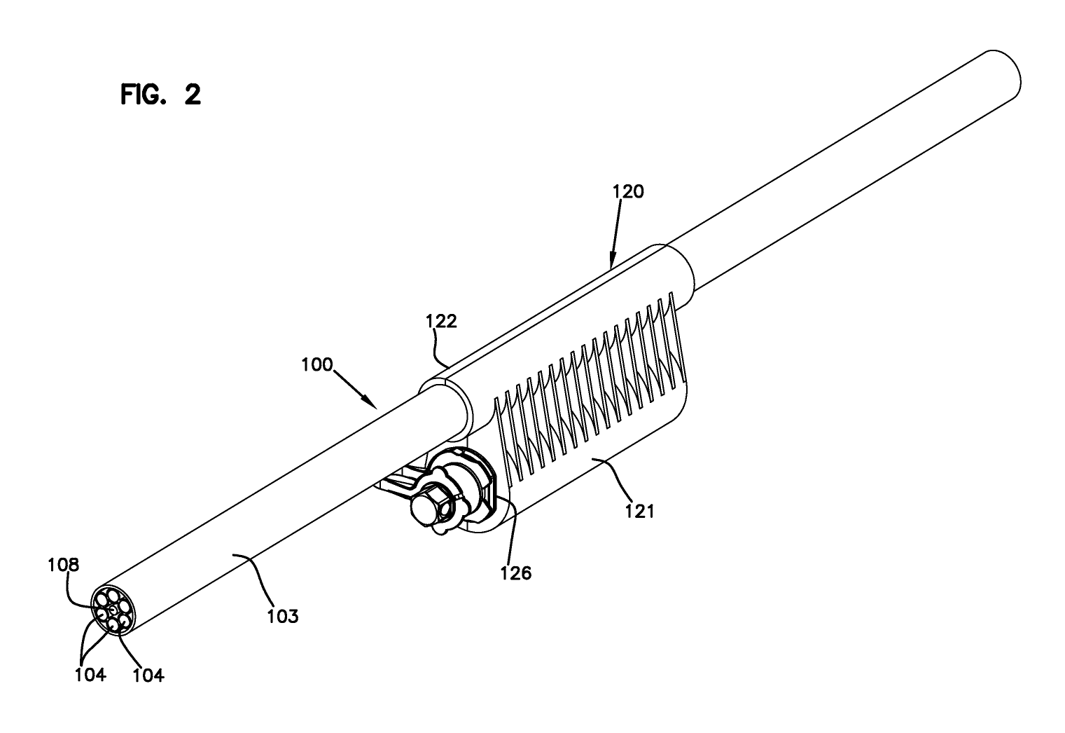

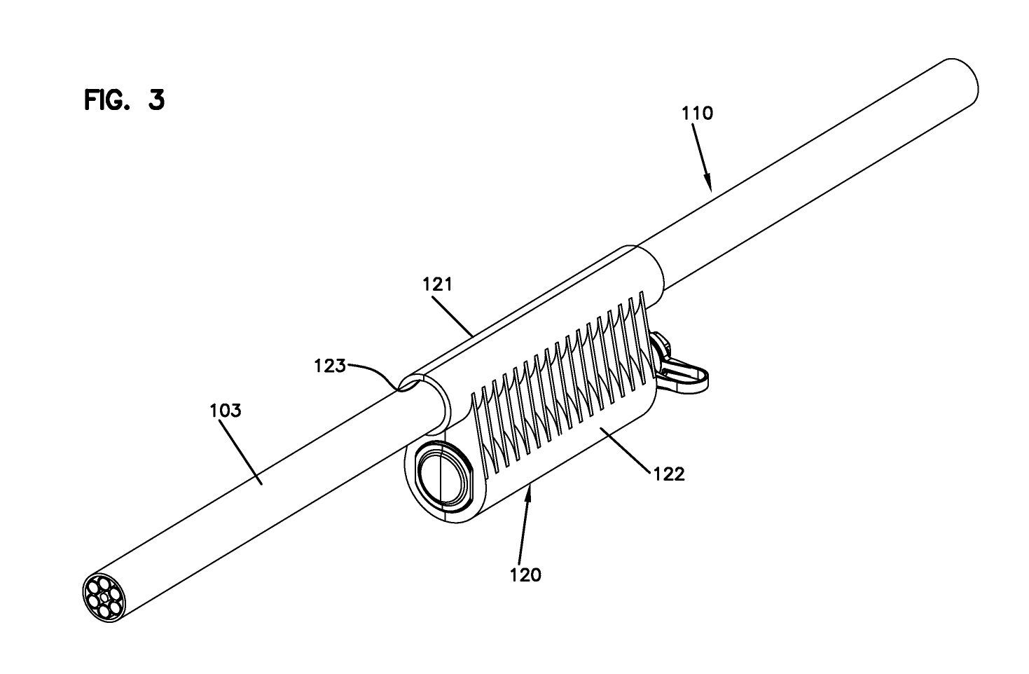

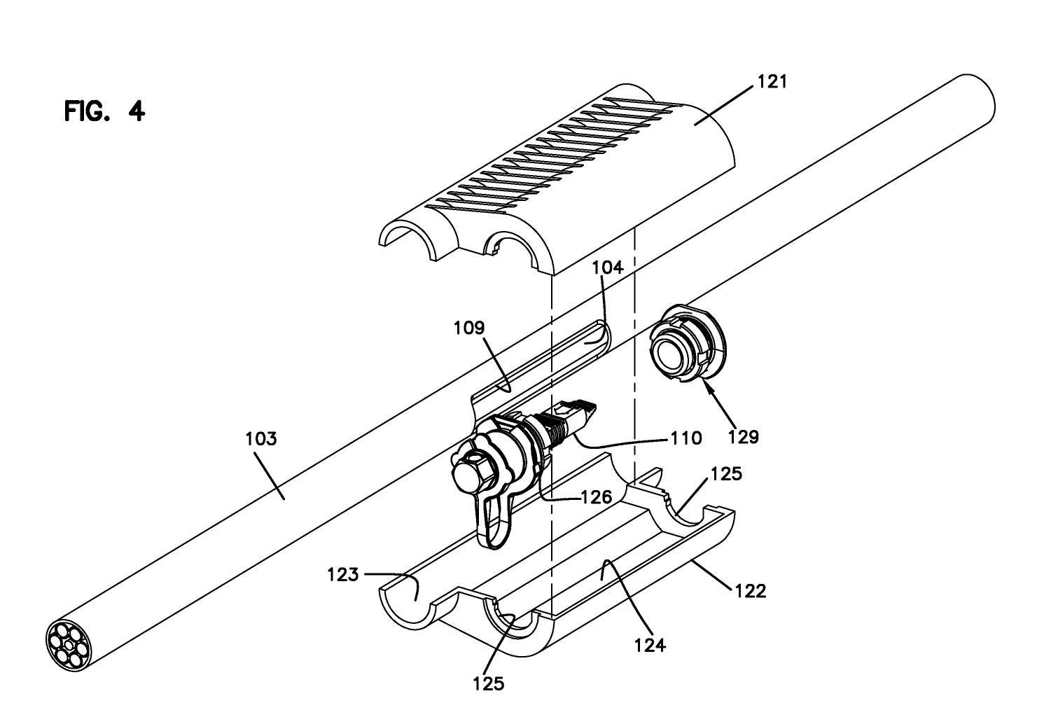

As shown in FIGS. 2-5, an example closure 120 can be mounted over the cable 100 at the access region 109. The closure 120 is configured to cover the access region 109 of the cable 100. In certain examples, the closure 120 also extends over jacketed portions of the cable 100 at opposite ends of the access region 109. In certain examples, the closure 120 can be sealed to the cable jacket 103 (e.g., via a gel seal, elastomeric gasket, adhesive, tape, a heat-recoverable sleeve, etc.). In certain implementations, the closure 120 includes a first housing piece 121 and a second housing piece 122 that cooperate (e.g., via a clam shell configuration) to surround the cable 100 at the access region 109.

In the example shown in FIGS. 2-5, the closure 120 defines a cable passage 123 extending therethrough. The cable passage 123 is sized and configured to receive the access region 109 of the cable 100. In certain examples, the cable passage 123 is sized and configured to receive jacketed portions of the cable 100 at opposite ends of the access region 109. The closure 120 also defines a routing cavity 124 in which the first cut end 106 extends out of the jacket 103. The closure 120 defines a cable port 125 providing access to the routing cavity 124 from an exterior of the closure 120. The routing cavity 124 is sufficiently sized to route the first optical connector 110 to the cable port 125 without violating a minimum bend radius limit of the fiber 105.

The cable port 125 is configured to align the optical connector 110 with an optical connector of an external cable. For example, an optical adapter 126 can be disposed at the cable port 125. As the term is used herein, an “optical adapter” is a structure configured to align at least one optical fiber of a first optical connector with at least one fiber of a second optical connector so that optical signals may be passed therebetween. The optical adapter 126 is disposed at the cable port 125 so that a first port of the optical adapter 126 (i.e., an external port) is accessible externally of the closure 120 and a second port of the optical adapter 126 (i.e., an internal port) is accessible internally of the closure 120.

In accordance with some aspects of the disclosure, the connection system between the optical adapter 126 and the optical connector 110 can be ruggedized. As the term is used herein, a connection is “ruggedized” when the optical connector and optical adapter are configured to environmentally seal together and are configured to robustly connect together. As the term is used herein, a “robust connection” refers to a connection of an optical connector to an optical adapter such that the optical connector can withstand an axial load of at least 100 pounds without pulling out of the optical adapter. In certain examples, a robust connection structure includes twist-to-lock connections. In an example, a twist-to-lock connection includes a bayonet connection. In another example, a twist-to-lock connection includes a threaded connection.

As the term is used herein, an optical adapter 126 is “ruggedized” when the optical adapter 126 environmentally seals to the closure 120 (e.g., using a gasket) and when at least one port of the optical adapter 126 is configured to provide a ruggedized connection to an optical connector received at the port. In some examples, a ruggedized port can include a seal (e.g., a gasket) disposed therein to press against an optical connector received in the port. In other examples, the ruggedized port can include a wall or other structure against which a seal on the connector may press when the connector is received at the port.

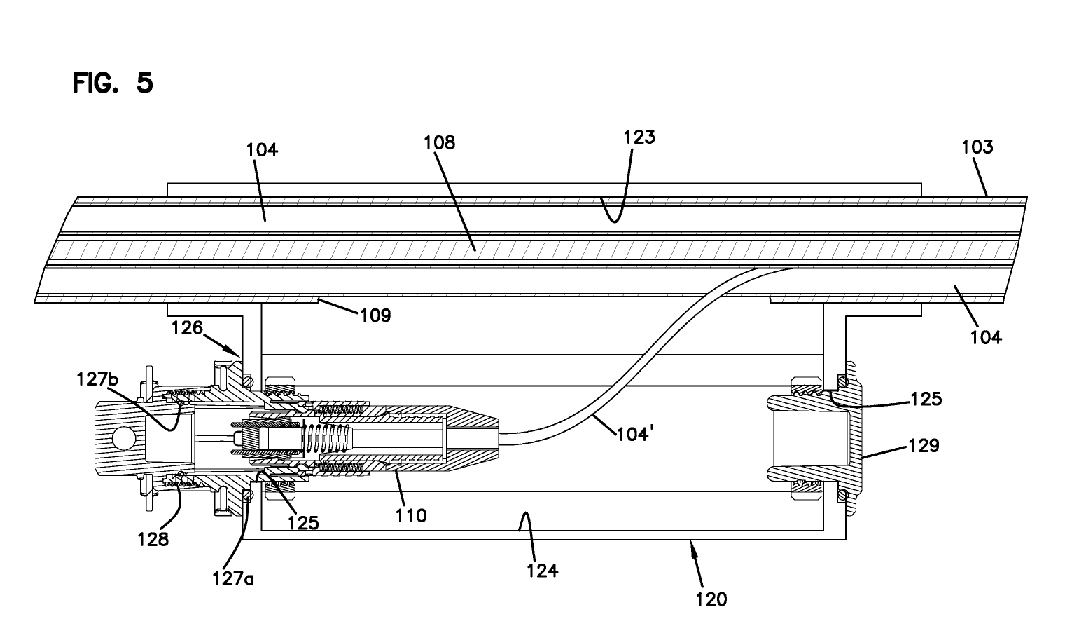

In the example shown in FIG. 5, an optical adapter 126 is mounted to the closure 120 at the cable port 125. The optical adapter 126 is a ruggedized optical adapter. The optical adapter 126 includes a first seal 127a disposed between an exterior of the optical adapter 126 and the closure 120. The optical adapter 126 has a ruggedized external port. In the example shown, the optical adapter 126 includes a second seal 127b disposed within the external port. The optical adapter 126 also includes a robust connection structure at the external port. In the example shown, the optical adapter 126 includes external threads 128. In other examples, the optical adapter 126 can include internal threads, a bayonet connection, or any other connection structure capable of withstanding a pull-out force of at least about 100 pounds.

In the example shown in FIG. 5, the optical adapter 126 has an internal port that is not ruggedized. Cut ends 106 of one or more cables 104′ are routed out of the jacket 103 to the internal port. For example, in certain implementations, a non-ruggedized internal port does not include a robust connection structure for receiving the first optical connector 110. In an example, the first optical connector 110 latches to the internal port of the optical adapter 126. In certain implementations, a non-ruggedized internal port is not configured to seal to an optical connector when the optical connector is received at the non-ruggedized internal port. In certain implementations, a non-ruggedized internal port does not include a seal and does not include a robust connection structure.

In some implementations, the closure 120 defines multiple cable ports 125. In certain implementations, fewer than all of the cable ports 125 of the closure 120 are populated when the cable 100 is deployed in the field. In certain implementations, a ruggedized plug 129 is received at any unpopulated cable ports 125. In the example shown in FIG. 5, a ruggedized plug 129 is sealed to the closure 120 and is threadably connected to the closure 120 at a cable port 125. If additional cables are to be connected to the cable 100 at the access region 109, then the ruggedized plug 129 would be removed from the port 125 and a ruggedized optical adapter 126 would be inserted into the port 125.

Referring now to FIGS. 6A and 6B, in accordance with some aspects of the disclosure, both the first and second cut ends 106, 107 of the cut optical cable 104′ can be terminated by first and second optical connectors 110, 115, respectively. Accordingly, optical signals received at the first end 101 of the cable 100 are passed to the first optical connector 110 and optical signals received at the second end 102 of the cable 100 are passed to the second optical connector 115.

As shown in FIG. 6A, the first cut end 106 can be directly terminated by the first optical connector 110 and the second cut end 107 can be directly terminated by a second optical connector 115. As shown in FIG. 6B, the first cut end 106 can be optically coupled via a splice 112 (e.g., mechanically spliced, fusion spliced, etc.) to a first stub fiber/cable 111 that is directly terminated by the first optical connector 110; and the second cut end 107 can be optical coupled via a splice 117 (e.g., mechanically spliced, fusion spliced, etc.) to a second stub fiber/cable 116 that is directly terminated by the second optical connector 115.

In certain examples, the opposite ends 101, 102 of the distribution cable 100 can be optically coupled to one or more central offices from which optical signals are provided to the optical network. For example, the cut optical cables 104′ can carry a first optical signal from a central office at the first end 101 of the cable 100 to the first cut end 106 and the cut optical cable 104′ can carry a second optical signal from a central office at the second end 102 of the cable 100 to the second cut end 107. In an example, each end 101, 102 of the cable 100 connects to a different central office. In another example, the ends 101, 102 of the cable 100 connect to the same central office. The cut ends 106, 107 of the optical cables 104′ can be optically coupled to cables leading to subscribers or other distribution points in the network. Accordingly, the optical signals can be provided to the subscribers from the central office(s) at either end of the distribution cable 100.

A closure is formed around the access region 109 to environmentally seal the cable 100 at the access region 109 to protect the optical fibers 105/cables 104. Cables located external of the closure can be mated to the optical connectors 110, 115 terminating the first and second cut ends 106, 107. The external cables can be routed to subscribers or to other distribution points of an optical network. In some implementations, the first and second optical connectors 110, 115 are disposed within the closure. In other implementations, the first and second optical connectors 110, 115 are disposed external of the closure.

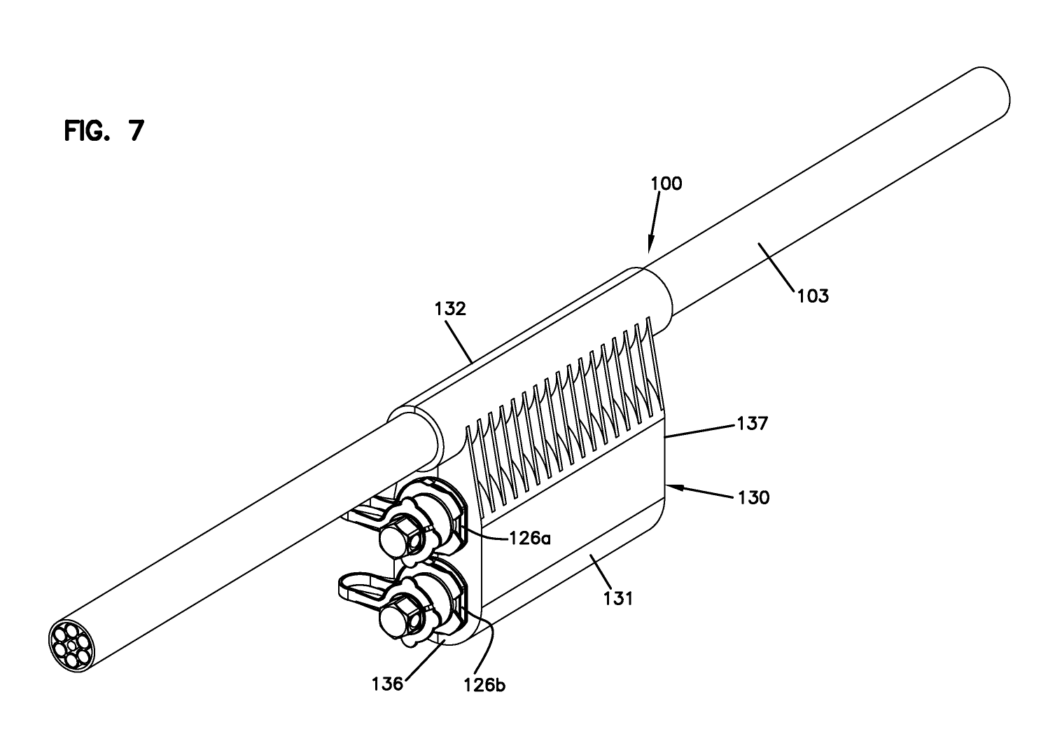

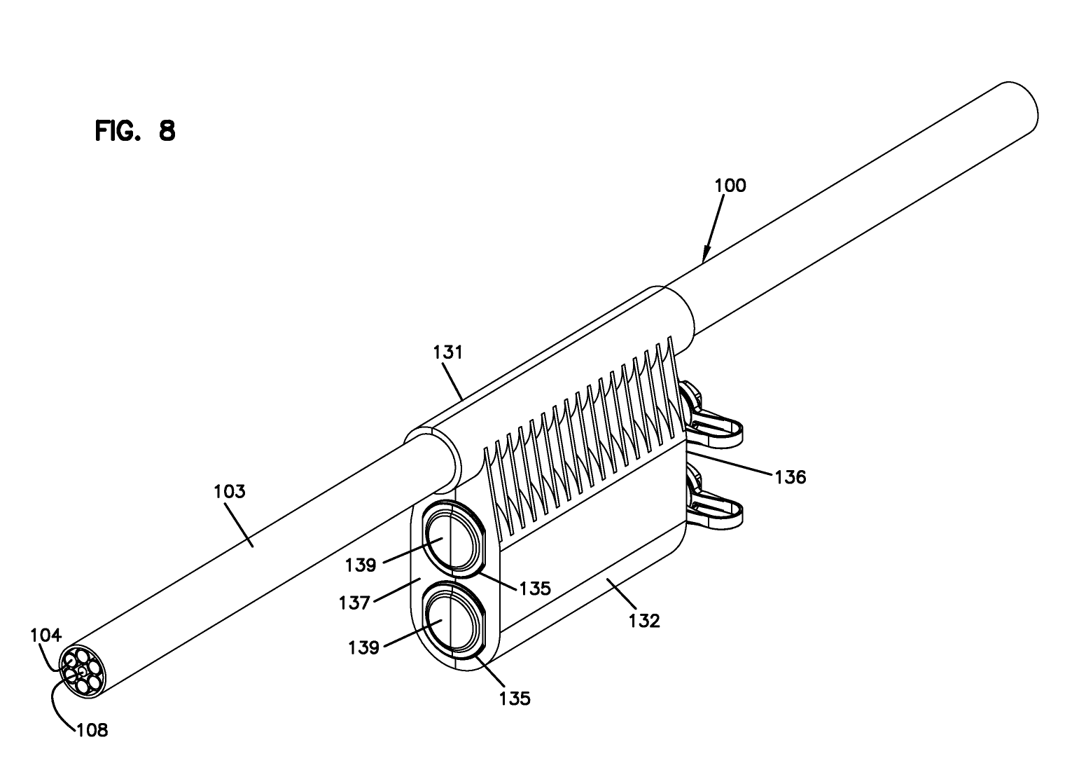

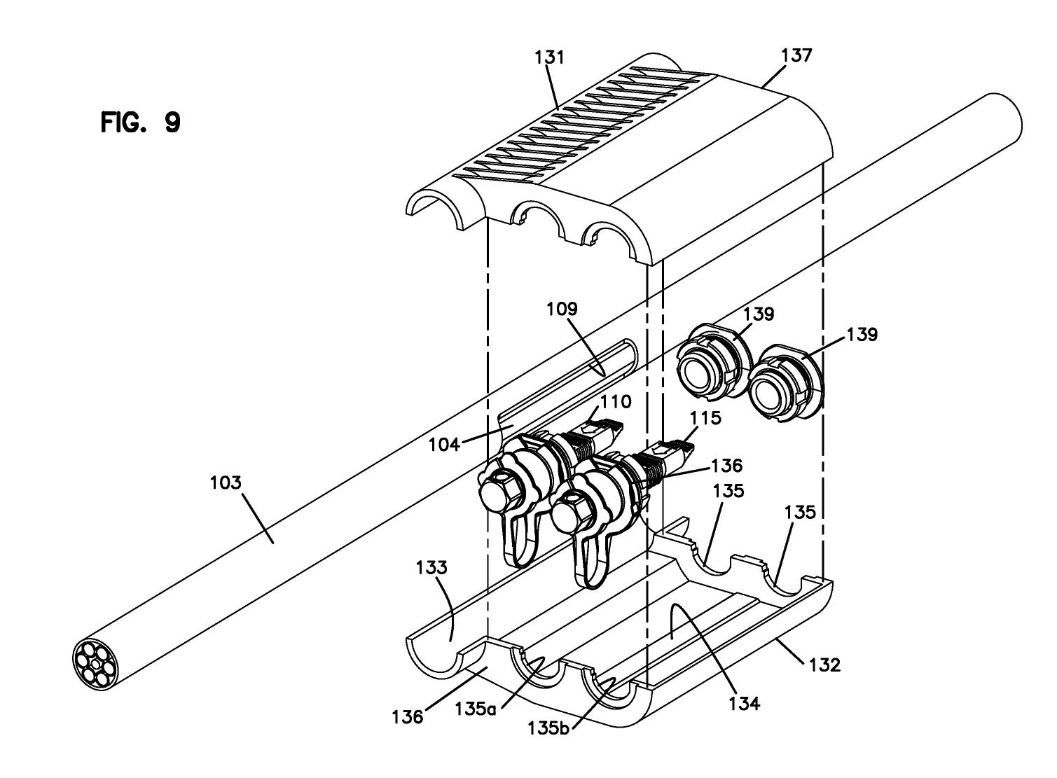

FIGS. 7-10 illustrate an example closure 130 in which the optical connectors 110, 115 can be disposed. The closure 130 can be mounted over the cable 100 at the access region 109. The closure 130 is configured to cover the access region 109 of the cable 100. In certain examples, the closure 130 also extends over jacketed portions of the cable 100 at opposite ends of the access region 109. In certain examples, the closure 130 can be sealed to the cable jacket 103 (e.g., via a gel seal, elastomeric gasket, adhesive, tape, a heat-recoverable sleeve, etc.). In certain implementations, the closure 130 includes a first housing piece 131 and a second housing piece 132 that cooperate (e.g., via a clam shell configuration) to surround the cable 100 at the access region 109.

In the example shown in FIGS. 7-10, the closure 130 extends from a first end 136 to a second end 137. The closure 130 defines a cable passage 133 extending therethrough between the first and second ends 136, 137. The cable passage 133 is sized and configured to receive the access region 109 of the cable 100. In certain examples, the cable passage 133 is sized and configured to receive jacketed portions of the cable 100 at opposite ends of the access region 109. In certain examples, the first and second housing pieces 131, 132 cooperate to define the cable passage 133.

The closure 130 also defines a routing cavity 134 into which the first cut end 106 extends out of the jacket 103. The closure 130 defines two or more cable ports 135 at which external cables (e.g., connectorized with hardened multi-fiber optical connectors) can be mated to the optical connectors 110, 115. The routing cavity 134 is sufficiently sized for routing the first and second optical connectors 110, 115 to the respective ports 135 without violating a minimum bend radius of the optical fibers 105.

In the example shown, the closure 130 defines a first cable port 135 at which an external cable can be mated to the first optical connector 110 and a second cable port 135b at which another external cable can be mated to the second optical connector 115. In some implementations, the first and second cable ports 135a, 135b are disposed at a common end (e.g., first end 136, second end 137) or side of the closure 130. In other implementations, cable ports 135 can be defined at both ends 136, 137 of the closure 130. In still other implementations, cable ports 135 can be defined at any desired portion of the closure 130.

In some implementations, a ruggedized optical adapter 126 (e.g., the ruggedized optical adapter 126 described above with reference to FIG. 5) can be disposed at one or more of the cable ports 135. In the example shown, a first ruggedized adapter 126a is disposed at the first cable port 135a and the second ruggedized adapter 126b is disposed at the second cable port 135b. In examples, the first and second ruggedized adapters 126a, 126b are disposed at a common end or side of the closure 130. In the example shown, the first and second ruggedized adapters 126a, 126b are disposed at the first end 136 of the closure 130. In other examples, however, the first and second ruggedized adapters 126a, 126b can be disposed at opposite ends 136, 137 of the closure 130. In still other examples, the first and second ruggedized adapters 126a, 126b can be disposed on the closure 130 in any desired configuration.

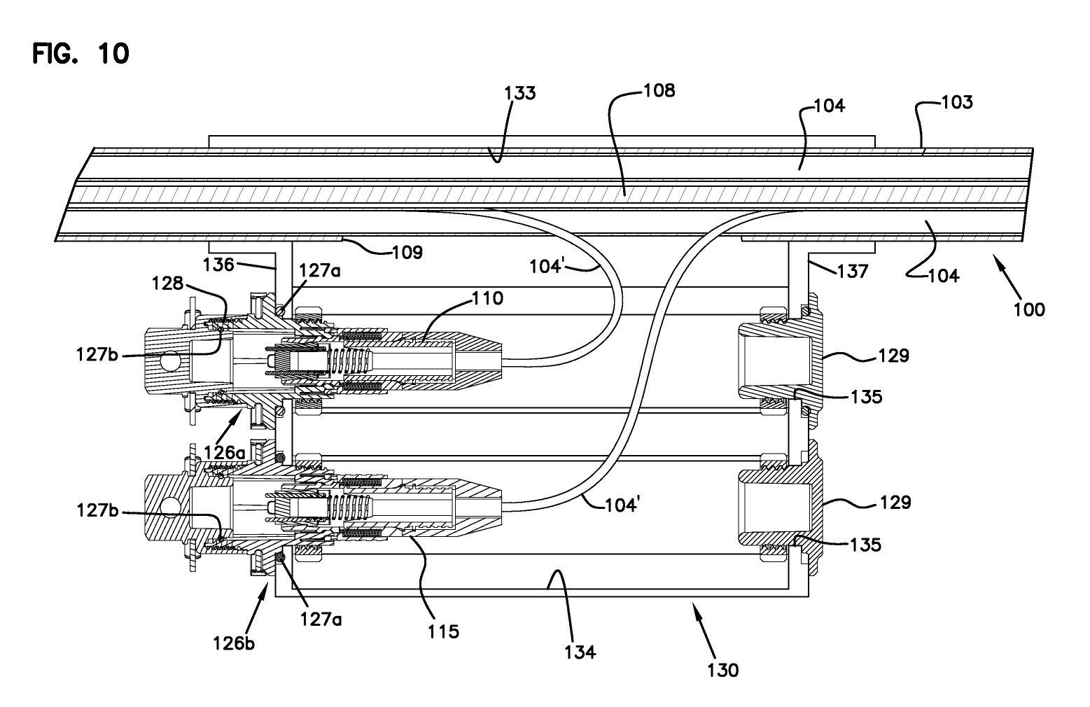

Cut ends 106, 107 of one or more optical cables 104′ are routed out of the jacket 103, through the routing cavity 134, and to the internal ports of the optical adapters 126a, 126b. The first optical connector 110 is plugged into the internal port of the first optical adapter 126a and the second optical connector 115 is plugged into the internal port of the second optical adapter 126b. In the example shown in FIG. 10, the external port of each optical adapter 126a, 126b is ruggedized and the internal port of each optical adapter 126a, 126b is not ruggedized. In other examples, however, the internal port of one or more of the optical adapters 126 also can be ruggedized. In still other examples, the external port of one or more optical adapters 126 is not ruggedized.

In some implementations, the closure 130 can define cable ports 135 in addition to the first and second cable ports 135a, 135b. In certain implementations, fewer than all of the cable ports 135 of the closure 130 are populated when the cable 100 is deployed in the field. In certain implementations, a ruggedized plug 129 is received at any unpopulated cable ports 135. In the example shown in FIG. 10, the ruggedized plugs 129 are sealed and threadably connected to the closure 130 at a cable port 135.

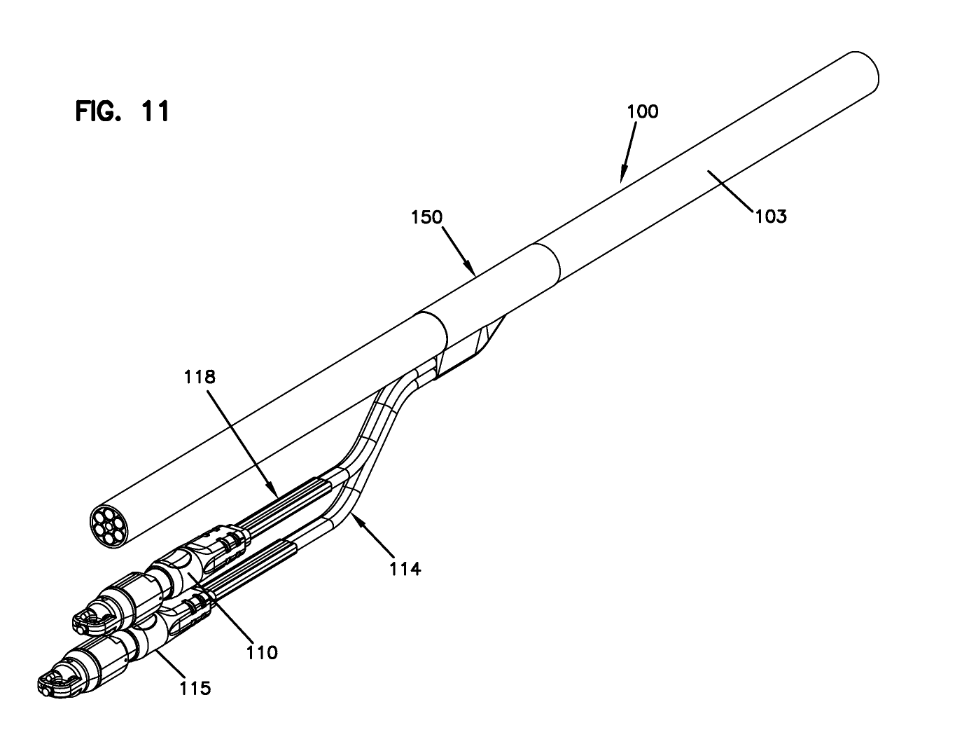

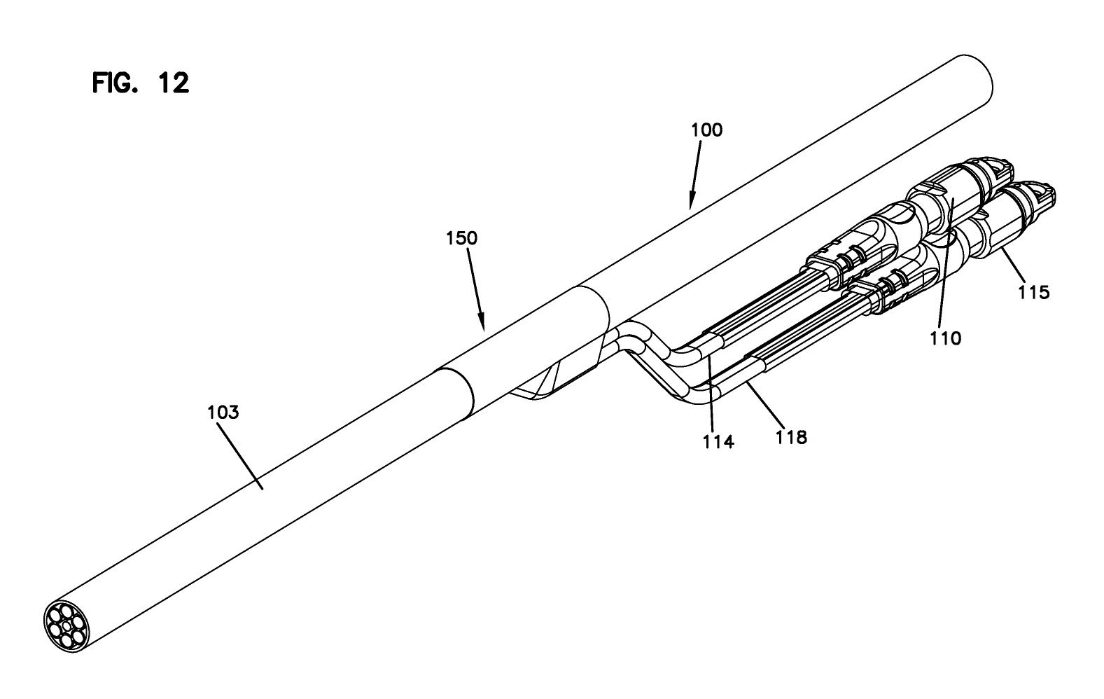

FIGS. 11-12 illustrate an example closure 150 suitable for covering the access opening 109 of the cable 100 while the first and second optical connectors 110, 115 are disposed external of the closure 150. In certain implementations, the first and second optical connectors 110, 115 are ruggedized optical connectors (e.g., hardened multi-fiber optical connectors (HMFOCs)). In such implementations, the first and second optical connectors 110, 115 are configured to environmentally seal the optical fibers terminated thereat when mated to a respective optical connector or to a respective optical adapter. In such implementations, the first and second optical connectors 110, 115 also are configured to robustly fasten to the respective optical connector or to the respective optical adapter.

In some implementations, each of the first and second optical connectors 110, 115 can include a watertight external seal configured to cooperate with a mating connector or mating adapter port to environmentally seal the optical fibers terminated by the first and second optical connectors 110, 115. In other implementations, each of the first and second optical connectors 110, 115 is configured to receive a mating connector or be received at a mating adapter having a watertight seal to environmentally seal the optical fibers terminated by the first and second optical connectors 110, 115. In some implementations, the first and second optical connectors 110, 115 include coupling nuts having internal threads. In other implementations, the first and second optical connectors 110, 115 include coupling nuts having external threads. In still other implementations, the first and second optical connectors 110, 115 include bayonet connection structure.

In some implementations, the first cut ends 106, 107 of the cut optical cable 104′ are directly terminated to the respective connectors 110, 115 by routing a length of each cut end 106, 107 out of the jacket 103 to extend along the cable 100 so that the optical connectors 110, 115 are directly terminated to the cut ends 106, 107 at a location spaced from the access region 109. In other implementations, the cut ends 106, 107 of the cut optical cable 104′ are terminated to the respective connectors 110, 115 by optically splicing (e.g., mechanically splicing, fusion splicing, etc.) the cut end 106, 107 to respective tether cables 114, 118 (e.g., by splicing the optical fibers 105′ at the cut ends 106, 107 to stub fibers 111, 116 of the tether cables 114, 118). The first and second tether cables 114, 118 are terminated by the first and second optical connectors 110, 115, respectively.

In some implementations, the closure 150 includes a heat recoverable closure that surrounds the cable 100 at the access region 109 and does not enclose the first and second optical connectors 110, 115. In certain implementations, the heat recoverable closure 150 also surrounds jacketed portions of the cable at opposite ends of the access region 109. In certain implementations, the heat recoverable closure 150 surrounds and protects (e.g., environmentally seals, inhibits access to, etc.) the splices between the cut ends 106, 107 and the stub fibers 111, 116.

In some implementations, the heat recoverable closure 150 includes a heat-recoverable material that is wrapped around the cable 100 at the access region 109. A clamp member (e.g., a metal clamp) can be disposed around the wrapped heat-recoverable material. In other implementations, the heat recoverable closure 150 can include a sheath threaded onto the cable 100 from one end 101, 102 of the cable 100.

Referring to the figures in general, an optical cable 100 can be manufactured with one or more of any of the above-described break-out locations at intermediate locations along a length of the cable 100. For example, one or more break-out locations can be formed on the cable 100 at a factory prior to deployment of the optical cable in the field. In other implementations, one or more break-out locations can be formed on the cable 100 in the field after deployment of the optical cable 100.

To add a break-out location to the optical cable 100, a portion of the jacket 103 is removed to provide an access region 109. At least one optical fiber 105′ of the cable 100 is accessed and cut at the access region 109. The first cut end 106 of the optical fiber(s) 105′ is terminated by the first optical connector 110. The second cut end 107 of the optical fiber(s) 105′ is terminated by the second optical connector 115. A closure 120, 130, 150 is disposed at the access region 109 of the cable 100.

In certain implementations, a first housing piece 121, 131 is positioned partially around the jacket 103 at the access region 109. A second housing piece 122, 132 is positioned partially around the jacket 103 so that the first and second housing pieces 121, 122, 131, 132 cooperate to form the closure 120, 130 that surrounds the jacket 103 and covers the access region 109. In examples, the first and second optical connectors 110, 115 are routed towards a common end of the closure 120, 130.

In some examples, the first optical connector 110 is plugged into an interior port of a first ruggedized optical adapter 126 carried by the closure 120, 130. In certain examples, the second optical connector 115 is plugged into an interior port of a second ruggedized optical adapter 126 carried by the closure 130. In other examples, a heat recoverable closure 150 is disposed around the access region 109 and not around the optical connectors 110, 115; and heat is applied to the heat recoverable closure 150 to shrink the heat recoverable closure 150 over the access region 109.

The above specification, examples and data provide a complete description of the manufacture and use of the structure of the invention. Since many embodiments of the invention can be made without departing from the spirit and scope of the invention, the invention resides in the claims hereinafter appended.

What is claimed is:

1. A distribution cable arrangement comprising:
a plurality of optical fibers extending along a length;
a jacket surrounding the optical fibers, the jacket defining an access region to provide access to at least one of the optical fibers;
at least one of the optical fibers being cut to provide a first cut end and a second cut end, both cut ends being routed out of the jacket through the access region, the first cut end being terminated at a first optical connector, and the second cut end being terminated at a second optical connector; and
a closure disposed around the jacket to cover the access region, wherein the first and second optical connectors are positioned relative to the closure to be mateable to optical cables that are external of the closure.

2. The distribution cable arrangement of claim 1, wherein the first and second optical connectors are multi-fiber connectors, and wherein a plurality of the optical fibers are cut to provide a plurality of first cut ends and a plurality of second cut ends, the first cut ends being terminated at the first optical connector, and the second cut ends being terminated at the second optical connector.

3. The distribution cable arrangement of claim 2, wherein the closure defines a first sealed cable connection location and a second sealed cable connection location, wherein the first optical connector plugs into an interior port of the first sealed cable connection location and the second optical connector plugs into an interior port of the second sealed cable connection location.

4. The distribution cable arrangement of claim 3, wherein the first cut ends are directly terminated at the first optical connector and wherein the second cut ends are directly terminated at the second optical connector.

5. The distribution cable arrangement of claim 3, wherein the first cut ends are optically spliced to first optical stub fibers that are directly terminated by the first optical connector and wherein the second cut ends are optically spliced to second optical stub fibers that are directly terminated by the second optical connector.

6. The distribution cable arrangement of claim 3, wherein the first and second sealed cable connection locations define ruggedized exterior ports.

7. The distribution cable arrangement of claim 3, wherein the first and second sealed cable connection locations are disposed at a common end of the closure.

8. The distribution cable arrangement of claim 4, wherein the closure includes a two-part housing that surrounds the jacket, carries first and second ruggedized optical adapters, and provides sufficient space for routing the first and second optical connectors to the respective interior ports without violating a minimum bend radius of the optical fibers.

9. The distribution cable arrangement of claim 2, wherein the first and second optical connectors are disposed external of the closure.

10. The distribution cable arrangement of claim 9, wherein the first and second optical connectors include ruggedized multi-fiber optical connectors.

11. The distribution cable arrangement of claim 9, wherein the first cut ends are terminated to the first optical connector by optically splicing at a splice location the first cut ends to a first end of a first multi-fiber tether cable that is directly terminated by the first optical connector; and wherein the second cut ends are terminated to the second optical connector by optically splicing the second cut ends to a second end of a second multi-fiber tether cable that is directly terminated by the second optical connector.

12. The distribution cable arrangement of claim 9, wherein the closure includes a heat recoverable closure that surrounds the jacket to cover the access region and does not enclose the first and second optical connectors.

13. A method of adding a distribution point to an optical fiber network comprising:
selecting an optical fiber cable;
removing a portion of the jacket of the optical fiber cable to provide an access region;
accessing at least one optical fiber of the optical fiber cable at the access region;
cutting the at least one optical fiber to obtain a first cut end and a second cut end that are routed out of the jacket at the access region;
terminating the first cut end at a first optical connector;
terminating the second cut end at a second optical connector; and
enclosing the jacket at the access region with a closure.

14. The method of claim 13, wherein enclosing the jacket comprises:
positioning a first housing piece partially around the jacket; and
positioning a second housing piece partially around the jacket so that the first and second housing pieces cooperate to form the closure that surrounds the jacket and covers the access region.

15. The method of claim 14, further comprising:
plugging the first optical connector into an interior port of a first ruggedized optical adapter carried by the closure; and
plugging the second optical connector into an interior port of a second ruggedized optical adapter carried by the closure.

16. The method of claim 15, further comprising:
routing the first optical connector to a first end of the closure to reach the interior port of the first ruggedized optical adapter; and
routing the second optical connector to the first end of the closure to reach the interior port of the second ruggedized optical adapter.

17. The method of claim 13, wherein the closure includes a heat recoverable closure, and wherein enclosing the jacket comprises:
disposing the heat recoverable closure around the access region and the jacket at opposite ends of the access region;
applying heat to the heat recoverable closure to shrink the heat recoverable closure over the jacket to cover the access region.

18. The method of claim 17, wherein the distribution cable extends from a first end to a second end, and wherein the method further comprises routing the first and second tether cables in a common direction away from the access region and along the distribution cable so that the first and second optical connectors are external of the heat recoverable closure.

19. The method of any of claims 13, wherein terminating the first cut end at the first optical connector comprises directly terminating the first cut end at the first optical connector; and wherein terminating the second cut end at the second optical connector comprises directly terminating the second cut end at the second optical connector.

20. The method of any of claims 13, wherein terminating the first cut end at the first optical connector comprises optical splicing the first cut end to a stub end of a first tether cable that is terminated by the first optical connector; and wherein terminating the second cut end at the second optical connector comprises optical splicing the second cut end to a stub end of a second tether cable that is terminated by the second optical connector.

21. The method of any of claims 13, wherein the method steps are implemented at a factory prior to deployment of the distribution cable in the field.
